(19) United States
(12) Patent Application Publication
(10) Pub. No.: US 2008/0145651 A1
(43) Pub. Date: Jun. 19, 2008

(54) Method for Manufacturing a Pecvd Carbon Coated Polymer Article and Article Obtained by Such Method

(75) Inventors: Jean-Michel Rius, Octeville-Sur-Mer (FR); Naima Boutroy, Octeville-Sur-Mer (FR); Christophe Delpech, Octeville-Sur-Mer (FR); Luc Desoutter, Octeville-Sur-Mer (FR); Leonard Jenkins, Atlanta, GA (US); Michael Okoroafor, Roswell, GA (US)

Correspondence Address: SUGHRUE MION, PLLC, 2100 PENNSYLVANIA AVENUE, N.W., SUITE 800, WASHINGTON, DC, 20037, US

(73) Assignee: Sidel Participations, Octeville-Sur Mer (FR)

(21) Appl. No.: 11/792,124

(22) PCT Filed: Dec. 1, 2004
(86) PCT No.: PCT/EP04/13629

§ 371 Date: Aug. 14, 2007

(51) Int. Cl. B32B 5/00; H05H 1/24

(52) U.S. Cl. 428/336; 427/575

(57) ABSTRACT

Method for manufacturing a polymer article having a thin carbon coating formed on at least one of its sides by plasma enhanced chemical vapor deposition, this method including: a first step, corresponding to a time T1 when the treatment pressure is reached in the treatment area, the reactive fluid being injected in the treatment area; a second step, corresponding to a time T2 during which electromagnetic field is applied in the treatment area, characterized in that time T1 is around 1.5 second, time T2 being around 1.2 second, the reactive fluid being a carbon precursor in the gaseous state, its flow being of around 100 sccm.

### FIELD OF THE INVENTION

The invention relates to a method for manufacturing a polymer article having a thin carbon coating formed on at least one of its side by plasma enhanced chemical vapour deposition (PECVD).

The invention relates also to a polymer article manufactured by the method, this article being of any shape and obtained by extrusion moulding, blow moulding, injection blow moulding, compression moulding, vacuum forming and the like.

The invention relates more particularly, thought not exclusively, to PET containers, e.g. blow moulded PET (polyethylene terephtalate) bottles.

Deposits by plasma enhanced chemical vapour deposition, also called cold plasmas, allow thin films to be deposited on temperature-sensitive objects made of plastic while ensuring a good physical-chemical adhesion of the coating deposited on the object.

It has recently been determined that such a technology can be used to coat plastic bottles with a barrier material, which bottles are used to package products that are sensitive to oxygen, such as beer and fruit juices, or carbonated products such as sodas.

### DESCRIPTION IF RELATED ART

The disadvantage of containers made from a polymer material such as PET is that they are not impermeable to certain gases, particularly oxygen and carbon dioxide.

This is the reason why carbonated drinks gradually lose their carbon dioxide to the air through the polymer substance: the shelf life of a carbonated liquid contained in a PET bottle will not be more than a few weeks in terms suitability for sale or at most a small number of months (for example four to six).

This is also the reason how oxygen in the air is able to penetrate the polymer material to come into contact with the liquid in the container, placing it at risk of oxidation accompanied by a deterioration in its properties: the shelf life of a bottle made from PET and filled with beer will not be more than a few weeks (for example two to five weeks) in terms of suitability for sale.

Conventional plastics used for containers permits low molecular gas, such as oxygen and carbon dioxide, to permeate there through, and furthermore, plastic sorbs inside therein low molecular inorganic compound. As a consequence, aroma component can be sorbed inside the plastic; oxygen can gradually oxidize the content of the container, deterioring flavour, quality and purity of said content.

A known approach to this problem is to enhance the natural barrier effect of the polymer substances used to make the containers by lining the polymer wall with a layer of material which has a stronger barrier effect.

Accordingly, it has been proposed that synthetic materials in multiple layers be used for this purpose, such as those based on aliphatic polyamides and/or mixtures of different substances. The containers are then made using multi-layered preforms, in which the layer of material with a barrier effect is located between at least two layers of polymer material (e.g. example PET). Beer bottles made in this manner will have a considerably longer shelf life (for example up to twelve months).

However, one major disadvantage of these multi-layered containers is that the layers will come unstuck from one another. In addition, making the preform, as well as making the container from the preform by blow-moulding or by stretching-blow-moulding, are quite complex processes and require certain precautions, which makes them expensive.

Another proposal is that polymer containers be treated by applying an external coating of an appropriate material such as those known as Plasma Vapour Deposition Coatings (PVDC) or thermo-setting resins. However, the gain in barrier effect achieved as a result is still quite low and the presence of the coating material leads to difficulties when it comes to recycling the basic polymer material.

Moreover, in all the known solutions mentioned above, the polymer material (for example PET) is left in contact with the liquid and does not offer any protection against the disadvantages incurred by this contact: possibility of certain constituents migrating from the polymer into the liquid, possibility of a chemical reaction between the polymer and liquid, acetaldehyde being transferred into the liquid, etc., all factors which are likely to give rise to organoleptic problems.

Another proposal is to make coatings by implementation of a Plasma Enhanced Chemical Vapour Deposition (PECVD) method.

Generally speaking, polymer containers with a barrier effect by implementation of PECVD are not very common due to the complexity inherent in the different processes, low production rates and the high cost of manufacturing methods of this type.

PECVD could be used for depositing a variety of thin films at lower temperature than those utilized in CVD reactors.

PECVD uses electrical energy to generate a glow discharge in which the energy is transferred into a gas mixture. This transforms the gas mixture into reactive radicals, ions, neutral atoms, electrons, molecules and other excited species.

PECVD is largely used in various fields of technology in depositing many films such as silicon nitride, diamond like carbon DLC, poly-silicon, amorphous silicon, silicon oxynitride, silicon oxide, silicon dioxide.

Silicon oxide films deposited by plasma enhanced chemical vapour deposition are receiving considerable attention in the packaging industry due to their excellent gas barrier performance.

These films are transparent and colourless.

U.S. Pat. No. 5,691,007 disclose a PECVD process whereby a coating of inorganic material may be placed on 3-D articles in a closely spaced matrix. This inorganic material can be a metal oxide such as SiOx wherein x is from about 1.4 to about 2.5; or an aluminium oxide based composition. The silicon oxide based composition is substantially dense and vapour-impervious and is desirably derived from volatile organosilicon compounds and an oxidizer such as oxygen or nitrous oxide. Preferably, the thickness of the silicon oxide based material is about 50 to 400 nm. Flow rates of 2.6 sccm hexamethyldisiloxane (HMDSO) and 70 sccm oxygen are established at a pressure regulated to 120 mTorr by pump throttling and a SiOx deposition step is implemented by applying an 11.9 MHz 120 watt RF excitation during 3 minutes on PET tube.

U.S. Pat. No. 6,338,870 disclose the use of hexamethyldisiloxane (HMDSO) or tetra-methyl-disiloxane (TMDSO) for the deposition of SiOxCy on PET laminated product wherein x is within the range of 1.5-2.2 and y is within the range of 0.15-0.80.

US 2003/0215652 disclose a polymeric substrate having a barrier coating comprising:
a polymeric substrate,
a first condensed plasma zone of SiOxCyHz, wherein x is from 1 to 2.4, y is from 0.2 to 2.4 and z is from zero to 4 on the polymeric substrate wherein the plasma is generated from an organosilane compound in an oxidizing atmosphere and
a further condensed plasma zone of SiOx on the polymeric substrate wherein the plasma is generated from an organosilane in a oxidizing atmosphere sufficient to form the SiOx.

This substrate is used for polymer bottle, particularly the non refillable bottle used for carbonated beverages, the aim of the coating being to be a barrier to the permeation of odorants, flavorants, ingredients, gas and water vapour. It is pretended that the condensed plasma coatings of this prior art document may be applied on any suitable substrate including polyolefin such as polypropylene or polyethylene.

The use is known of dense coatings with an SiOx type silicon oxide base deposited by low-pressure plasma to reduce the permeability of plastic substrates. However, when they are deposited on deformable substrates, these coatings are unable to resist the deformations that the substrate undergoes. Indeed, in spite of the very strong adhesion to the substrate, the deformation thereof leads to the appearance of micro-cracks in the coating, which impairs the barrier properties.

Some applications require that the coating be able to resist the deformations of the substrate. Thus, a PET bottle full of a carbonated liquid such as soda or beer is subject to an internal pressure of several bars which, in the case of the lightest bottles, can lead to creep in the plastic material resulting in a slight increase in the bottle's volume. In this case, dense materials like SiOx, because they have an elasticity that is much lower than that of the plastic substrate, can deteriorate to the point of losing a large part of the bottle's barrier properties. To obtain a better resistance for the silicon layer to the different deformations of the plastic substrates, it is suggested by document US 2004/0076836 to form a gas barrier coating deposited on a polymer substrate such as PET by low-pressure plasma, with a silicon oxide base that is covered with a protective layer of hydrogenated amorphous carbon, the barrier layer being composed essentially of silicon oxide with the formula SiOx, where x is between 1.5 and 2.3, the barrier layer having a thickness of between 8 and 20 nanometers and the protective layer having an interface layer being deposited between the substrate and the barrier layer, the interface layer being obtained by plasma deposition of an organosilicon compound in the absence of additional oxygen. Such a high cost method is complex and of relatively low production rates.

It has also been proposed that a layer of hard carbon be applied to a wall made from polymer, for example PET, using plasma, e.g document U.S. Pat. No. 5,041,303. Document EP 0 773 166 also mentions the possibility of forming such a layer of carbon on the internal face of the container wall.

If a relatively thick layer of hard carbon or diamond-like carbon (DLC) is used, the wall of a container made in this way would therefore have an internal layer of hard carbon DLC, which is quite rigid, and an external layer of polymer material such as PET, which is highly deformable. Due to their differing and incompatible mechanical properties, the two layers of polymer and hard carbon end up coming apart or unstuck.

Document US 2002/0179603 disclose a container such as a bottle or flask, heterogeneously made from a material with a barrier effect and a polymer material which, the material producing the barrier effect consisting of a highly hydrogenated amorphous carbon material, which is applied to a substrate of polymer material. The substrate is a blank of the container and already has the final shape of the container. By highly hydrogenated amorphous carbon material is meant carbon containing not only CH and CH₂ bonds found in the hard carbon, but also CH₃ bonds which are absent in hard carbon.

As document US 2002/0179603 mentions, inherent in their physical and chemical structure, highly hydrogenated amorphous carbon materials have a lower molecular permeability coefficient than hard carbon which has been used to date.

As also mentioned in US 2002/0179603, highly hydrogenated amorphous carbon is amber in colour which helps to protect against ultraviolet and visible rays (as a protection for beer in particular).

However, such colour could affect the appearance of the content of the bottle, such as fruit juice.

Document WO99/49991 describes a device and a method that allows the internal or external face of a plastic bottle to be covered with a highly hydrogenated amorphous carbon coating by using acetylene as a reactive fluid. The method described in this document makes it possible to form a particularly effective coating layer in a single step. However, to obtain good barrier values, it is necessary to deposit a thickness on the order of 80 to 200 nanometers because thickness of more than this produce again a not negligible yellowish coloration of the carbon layer, as mentioned in US 2004/0076836.

Document US 2003/0150858 disclose a method of depositing thin film coatings using such plasma enhanced chemical vapour deposition. The reactive fluid is injected under low pressure into a treatment area. This fluid, when it is brought up to the pressures used, is generally gaseous. In the treatment area, microwaves are generated to change this fluid over to the plasma state, that is, to cause at least an ionization thereof. The particles issuing from this ionization mechanism can then be deposited on the walls of the object that is placed in the treatment area. The plasma is obtained by species ionization, under the action of the microwave energy, of a reactive fluid injected under low pressure into a treatment area, the method comprising at least two steps:
a first step in which the reactive fluid is injected into the treatment area with a first flow rate and under a given pressure; and
a second step in which the same reactive fluid is injected into the treatment area with a second flow rate that is lower than the first flow rate.

The reactive fluid used being a gaseous hydrocarbonated compound such as acetylene, the material deposited by such method is a highly hydrogenated amorphous carbon.

Beginning at the moment to when the treatment pressure is reached in the treatment area, that is, inside the container, the reactive fluid is injected into the treatment area.

Beginning at the moment t₁, the microwave energy is applied in the treatment area. Preferably, the moments t₀ and t₁ are separated by enough time to perform a complete sweep of the container with the reactive fluid, in order to purge the treatment area as much as possible of traces of air that remain in spite of the vacuum initially created.

For the entire time between moments t₁ and t₂, a first deposition stage is carried out under conditions that make it possible to obtain an optimal deposition speed on the inner wall of the container.

A flow rate of acetylene on the order of 160 sccm (standard cubic centimeters per minute), under a pressure of about 10⁻⁴ bar, with a microwave energy power on the order of 400 watts is disclosed. Under these conditions, to treat a container of about 500 ml, the sweep time between moments t₀ and t₁ can be on the order of 200 to 600 ms, and
a second step, corresponding to a time T2 during which the electromagnetic field is applied in the treatment area,
characterized in that time T1 is around 1.5 second, time T2 being around 1.2 second, the reactive fluid being C₂H₂, its flow being of around 100 sccm.

Another subject of the present invention is a polymer article manufactured by said method, this article being of any shape and obtained by extrusion moulding, blow moulding, compression moulding, vacuum forming and the like, characterized in that the carbon coating is highly hydrogenated amorphous carbon having a thickness of around 50 nanometers.

A microwave excitation is generated in a reaction chamber at a relatively low power sufficient to generate a plasma under temperature conditions which will maintain the polymer at a temperature below its glass transition temperature, said power being of around 200 W using a frequency of 2.45 GHz.

The carbon coating is a highly hydrogenated amorphous carbon. Such a coating appears to be adapted to flexible polymer as PET used for carbonated drinks.

According to one embodiment, carbon precursor acetylene, the carbon coating being applied on the interior of said polymer article.

The polymer article can be of any shape and obtained by extrusion moulding, blow moulding, compression moulding, vacuum forming and the like.

### DETAILED DESCRIPTION OF THE PREFERRED EMBODIMENT

So as to illustrate the results available by the present invention, comparative trials are presented below. These trials have been made on 390 ml (13 Oz) 26.5 g PET bottles coated using a coating machine having an output of in any event less than 1 second. The time of the first treatment step can vary between 600 ms and 3 seconds, depending on the performance that one wishes to achieve.

At moment t₂ a second deposition stage begins which should develop with a reactive fluid flow rate that is lower than the one used in the first step. Under the implementation conditions described above, the length of this second step is essentially between 500 ms and 2.5 seconds.

One object of the invention is to optimize the deposition of carbon, using plasma enhanced chemical vapour deposition, reducing the impact of the deposition on the colour of the final product.

Another object of the invention is to optimize the deposition of carbon, using plasma enhanced chemical vapour deposition, obtaining a very high level of barrier properties with a uniform coating.

Another object of the invention is to optimize the deposition of the deposition of carbon, using plasma enhanced chemical vapour deposition, obtaining higher production rates and lower costs of manufacturing when compared with prior art techniques.

### SUMMARY OF THE INVENTION

One subject of the invention is a method for manufacturing a polymer article having a thin carbon coating formed on at least one of its side by plasma enhanced chemical vapour deposition, this method comprising:
a first step, corresponding to a time T1 when the treatment pressure is reached in the treatment area, that is, inside the polymer article, the reactive fluid being injected inside said polymer article ; 10 000 bottles per hour.

Table 1 below gives the parameters used for a method according to the present invention (I) and for comparative examples (C1 to C10).

TABLE 1
T1, T2, Microwave power and gas flow rates

| | I | C1 | C2 | C3 | C4 | C5 | C6 | C7 | C8 | C9 | C10 |
|---|---|---|---|---|---|---|---|---|---|---|---|
| Power (% of the maximum 850 W | 25 | 30 | 30 | 30 | 30 | 25 | 30 | 25 | 25 | 25 | 30 |
| power of the machine) | | | | | | | | | | | |
| T1 (s) | 1.5 | 1 | 1 | 1 | 1 | 1 | 1 | 1 | 1 | 1 | 1.5 |
| T2 (s) | 1.2 | 1.2 | 1.2 | 1 | 1 | 1.4 | 1.4 | 1.2 | 1 | 1.2 | 1.2 |
| C₂H₂ flow (sccm) | 100 | 120 | 100 | 100 | 120 | 90 | 100 | 90 | 90 | 100 | 100 |

Colour was evaluated using the CIE procedure, as defined in 1976.

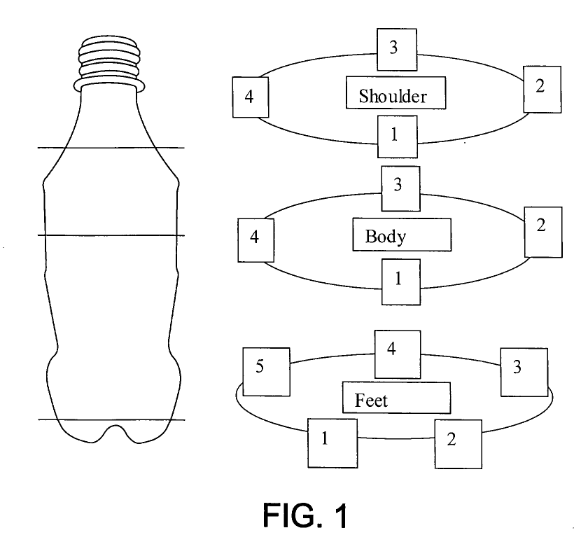

For each bottle, measurements have been made on the shoulder, the body and the feet. Four measurement areas were defined on the shoulder, four measurement areas were used also on the body and five measurement areas were defined on the feet as show on FIG. 1.

A UV Visible spectrometer 35 Perkins and Elmer was used, with a labsphere RSA PE 20 as integrated sphere. Transmittance measurements were made between 400 and 700 nm.

Colour calculation were made with CIE 1964 L*a*b* database, illuminant D65, observer 10°.

Colour measurement results are given below in Table 2.

TABLE 2
Colour measurements using the CIE L*a*b* database

| | Non | | | | | | | | | | | |
|---|---|---|---|---|---|---|---|---|---|---|---|---|
| | coated | I | C1 | C2 | C3 | C4 | C5 | C6 | C7 | C8 | C9 | C10 |
| L* | 94.38 | 93.17 | 92.73 | 93.32 | 94.38 | 93.28 | 93.53 | 93.44 | 93.60 | 94.04 | 93.28 | 93.18 |
| a* | −0.24 | −0.28 | −0.27 | −0.27 | −0.37 | −0.27 | −0.30 | −0.26 | −0.29 | −0.28 | −0.19 | −0.19 |
| b* | 1.28 | 4.64 | 5.09 | 4.59 | 3.80 | 5.14 | 4.78 | 4.97 | 4.63 | 4.44 | 5.07 | 5.00 |

O2 transmission rate (OTR) was measured using a Mocon/Oxtran apparatus.

Results are presented below in Table 3.

TABLE 3
O2 transmission rate using a Mocon/Oxtran
apparatus

| | I | C1 | C2 | C3 | C4 | C5 | C6 | C7 | C8 |
|---|---|---|---|---|---|---|---|---|---|
| O₂ permeation | 0.0010 | 0.0006 | 0.0030 | 0.0035 | 0.0041 | 0.0037 | 0.0040 | 0.0032 | 0.0022 |
| (cc/btle/24 h) | to | to | | | | | | | |
| | 0.0028 | 0.0040 | | | | | | | |

CO2 loss control and predictions on losses were done on bottles filled with dry ice using proprietary procedures and on bottles filled with carbonated water using Zahm and Nagel tables.

For the proprietary procedures, three test have been implemented, with the following conditions:

a) First Test Conditions (Standard Procedure): Initial carbonation: bottle filled with dry ice generating a pressure of about 56 psi at 23° C.

Cap: Bericap® polyvent standard with blue liner

Storage conditions: temperature 23° C., ambient humidity.

b) Second Test Conditions (Procedure at 23° C.):

Initial carbonation: bottle filled with dry ice generating a pressure of about 62 psi at 23° C.

Cap: Bericap® polyvent standard with blue liner

Storage conditions: temperature 23° C., 100% humidity.

c) Third Test Conditions (Procedure at 38° C.):

Initial carbonation: bottle filled with dry ice generating a pressure of about 96 psi at 38° C.

Cap: Bericap® polyvent standard with blue liner

Storage conditions: temperature 38° C., 85% humidity.

The Zahm and Nagel table was used as follows:

bottles filled with carbonated water under conditions below
water deaeration, carbonation and filling with cabofill FT102
pressure and temperature controls
initial carbonation levels:
   uncoated 4.02 vol

Comparative example C1: 4.08 vol.

Invention: 4.07 vol.

Storage at 23, 30 and 38° C.

Results are presented in Tables below.

TABLE 4
Co₂ losses standard procedure

| | Time (weeks) | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| % CO₂ lost I | 0 | 1.3 | 1.8 | 2.3 | 2.8 | 3.1 | 3.6 | 4 | 4.4 | 4.9 | 5.7 | 6.2 | 6.7 | 7.2 | 7.5 |
| % CO₂ lost | 0 | 1.2 | 1.8 | 2.4 | 2.8 | 3.3 | 3.8 | 4.2 | 4.7 | 5 | 5.8 | 6.4 | 6.8 | 7.2 | 7.7 |
| C1 | | | | | | | | | | | | | | | |
| % CO₂ lost | 0 | 3.7 | 5.6 | 7.5 | 9 | 10.6 | 12.2 | 13.6 | 14.8 | 16.6 | 19.2 | 20.5 | 21.8 | 23.1 | 24.3 |
| non treated | | | | | | | | | | | | | | | |
| bottle | | | | | | | | | | | | | | | |

TABLE 5
CO₂ losses procedure at 23° C.

| | Time (weeks) | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| % CO₂ lost I | 0 | 1.8 | 2.6 | 3.1 | 3.8 | 4.4 | 5.2 | 5.7 | 6.3 | 7 | 7.6 | 8.2 | 8.8 | 9.3 | 10.1 |
| % CO₂ lost C1 | 0 | 1.8 | 2.8 | 3.3 | 4 | 4.6 | 5.4 | 6.1 | 6.5 | 7.1 | 7.8 | 8.3 | 9 | 9.6 | 10.4 |

TABLE 6
CO₂ losses procedure at 38° C.

| | Time (weeks) | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| % CO₂ lost I | 0 | 7.6 | 10.3 | 12.5 | 14.7 | 16.9 | 19 | 21.1 | 23 | 25 | 26.8 | 28.5 | 30.3 | 31.8 | 33.5 |
| % CO₂ lost C1 | 0 | 7.7 | 10.7 | 13.1 | 15.6 | 17.8 | 20 | 22.2 | 24.3 | 26.5 | 28.5 | 30.4 | 32.4 | 34.2 | 36.9 |

TABLE 7
Carbonation losses at 38° C. (Zahm and Nagel)

| Time (days) | Uncoated bottle | Time (days) | I | Times (days) | C1 |
|---|---|---|---|---|---|
| 0 | 0 | 0 | 0 | 0 | 0 |
| 14 | 0.74 | 14 | 0.52 | 14 | 0.55 |
| 28 | 1.02 | 28 | 0.58 | 28 | 0.65 |
| 42 | 1.3 | 42 | 0.80 | 42 | 0.84 |
| 56 | | 60 | 0.92 | 61 | 1.03 |

TABLE 8
Carbonation losses at 30° C. (Zahm and Nagel)

| Time (days) | Uncoated bottle | Time (days) | I | Times (days) | C1 |
|---|---|---|---|---|---|
| 0 | 0 | 0 | 0 | 0 | 0 |
| 14 | 0.59 | 14 | 0.37 | 14 | 0.39 |
| 28 | 0.76 | 28 | 0.40 | 28 | 0.47 |
| 42 | 0.98 | 42 | 0.54 | 42 | 0.59 |
| 56 | 1.15 | 60 | 0.62 | 61 | 0.70 |
| 84 | | 84 | 0.77 | 84 | 0.82 |
| 112 | | 113 | 0.9 | 112 | 0.94 |

TABLE 9
Carbonation losses at 23° C. (Zahm and Nagel)

| Time (days) | Uncoated bottle | Time (days) | I | Times (days) | C1 |
|---|---|---|---|---|---|
| 0 | 0 | 0 | 0 | 0 | 0 |
| 14 | 0.44 | 14 | 0.29 | 14 | 0.30 |
| 28 | 0.52 | 28 | 0.30 | 28 | 0.30 |
| 42 | 0.7 | 42 | 0.34 | 42 | 0.41 |
| 56 | 0.82 | 60 | 0.42 | 61 | 0.44 |
| 84 | 1.03 | 84 | 0.48 | 84 | 0.53 |
| 113 | 1.11 | 112 | 0.56 | 111 | 0.59 |

TABLE 10
Shelf life for 0.7 volume CO₂ losses

| | 23° C. | 30° C. | 35° C. | 40° C. |
|---|---|---|---|---|
| T2 = 1.2 s I | 23.0 | 10.7 | | 5.1 |
| T2 = 1.2 s C1 | 20.2 | 9.3 | | 4.3 |
| uncotated | 6.6 | 3.2 | 4.2 | 1.7 |

Thickness measurements were also made at the same location as for colour measurements.

TABLE 11
Thickness in nm for the carbon deposit.

| | | |
|---|---|---|
| T2 = 1.2 s | 45.2 | 51.9 |

The bottles obtained by the present invention can be used for beer, tea, soft drinks carbonated.

Bearing in mind that the closure contribution to shelf life (CO₂ losses) is rather low, especially for large containers (2 liters, 54 g), the present invention can be nevertheless of major interest for large soft drinks bottles.

A low b* value is also of interest not to alter the visual aspect of some beverage such as fruit juice.

1. Method for manufacturing a polymer article having a thin carbon coating formed on at least one of its sides by plasma enhanced chemical vapour deposition (PECVD), this method comprising:
a first step, corresponding to a time T1 when the treatment pressure is reached in the treatment area, the reactive fluid being injected in the treatment area;
a second step, corresponding to a time T2 during which microwaves energy is applied in the treatment area, characterized in that time T1 is around 1.5 second, time T2 being around 1.2 second, the reactive fluid being a carbon precursor in the gaseous state, its flow being of around 100 sccm.

2. Method according to claim 1, wherein a microwave excitation is generated in a reaction chamber at a relatively low power sufficient to generate a plasma under temperature conditions which will maintain the polymer at a temperature below its glass transition temperature, said power being of around 200 W using a frequency of 2.45 GHz.

3. Method according to claim 1, wherein the carbon coating is a highly hydrogenated amorphous carbon.

4. Method according to claim 1, wherein said carbon precursor is acetylene.

5. Method according to claim 1, wherein the carbon coating is applied on the interior of said polymer article.

6. Polymer article manufactured by the method of claim 1, this article being of any shape and obtained by extrusion moulding, blow moulding, compression moulding, vacuum forming and the like, characterized in that the carbon coating is a highly hydrogenated amorphous carbon having a thickness of around 50 nanometers.

7. Polymer article according to claim 6, wherein it is made of polyethylene terephtalate.

8. Polymer article according to claim 6, wherein its b* value measured using the CIE 1964 L*a*b* database is below 5.

9. Polymer article according to claim 6, wherein its oxygen transmission rate is below 0.0030 cc/24 h.

10. Polymer article according to claim 6, wherein its shelf life for 0.7 volume CO₂ losses is around 23 weeks at 23° C.

11. Polymer article according to claim 6, wherein its shelf life for 0.7 volume CO₂ losses is around 10 weeks at 30° C.

12. Polymer article according to claim 6, wherein its shelf life for 0.7 volume CO₂ losses is around 5 weeks at 40° C.

13. Polymer article according to claim 6, wherein it is a 390 ml (13 Oz) 26.5 g PET bottle.
